(19) United States
(12) Patent Application Publication
(10) Pub. No.: US 2003/0019342 A1
(43) Pub. Date: Jan. 30, 2003

(54) Suction assembly for the cutting surface of machines for cutting sheet materials

(76) Inventor: Matteo Zanesi, Pavia (IT)

Correspondence Address: James V. Costigan, Esq., Hedman & Costigan, P.C., Suite 2003, 1185 Avenue of the Americas, New York, NY, 10036-2646, US

(21) Appl. No.: 10/199,383

(22) Filed: Jul. 19, 2002

(30) Foreign Application Priority Data
Jul. 26, 2001 (IT) MI2001A 001626

(51) Int. Cl. B26D 7/01; B26D 7/20

(52) U.S. Cl. 83/100; 83/402; 83/423; 83/941

(57) ABSTRACT

A suction assembly (10, 10′), which constitutes a portion of a cutting surface (11) of machines for cutting sheet materials (9), in which a blade working with reciprocating motion freely penetrates, comprises modular supporting elements (13), which are of small thickness and comb-shaped and are provided with a row of bristles (16) and a base (17), which is provided with engagement means (19, 21) for insertion of said elements (13) in a removable way and appropriately oriented on a bearing structure (14, 15) to form a mat of bristles, on which the sheet materials (9) rest, the said suction assembly (10, 10′) being provided with channels, connected to a suction system, consisting of a plurality of grooves (23) made on at least one side of the base (17) of the modular supporting elements (13).

The present invention relates to a suction assembly for the cutting surface of machines for cutting sheet materials.

By sheet materials are meant traditional cloth fabrics, technical fabrics, composite materials, such as plastic reinforced with fibre glass, plastic materials, and other materials suited for being cut by a reciprocating blade.

In machines for automatic cutting of fabrics, to which reference will be made in what follows for reasons of simplicity of exposition, a moving element bearing a blade provided with reciprocating motion, is guided by an electronic control system on a cutting surface on which the fabric is positioned. Feeding of the fabric is of the conveyor-belt type, driven by a chain device.

The cutting surface must ensure a good adherence of the fabric undergoing the working process, as well as enable the blade to penetrate freely into the fabric during the cutting operations.

Currently, the cutting surface is made in the form of a mat of bristles, obtained through the assemblage of blocks of arrays of bristles on a supporting structure. The mat of bristles thus formed enables the blade to penetrate, as well as to perform a translational movement in any direction to carry out the cutting operation.

The tips of the bristles of the blocks set alongside one another identify a flat resting surface for the fabric, which is kept adherent thereto by means of a negative pressure applied between the bristles.

In fact, the blocks of bristles are provided with suction channels that communicate with an underlying chamber, which is, in turn, connected to a suction system.

Over the years, in the field of automatic cutting machines for fabrics, although the use of a mat of bristles as resting surface has remained unaltered, various embodiments of the blocks of bristles have been proposed, which differ from one another as regards the portion co-operating with the structure.

The aim has been, for example, to optimize suction through different types of channels, but, above all, numerous systems of constraint have been developed, for instance, for facilitating the operation of replacing worn-out blocks.

The main drawback of the embodiments proposed lies in the geometrical complexity of the individual elements, which gives rise to high production costs of the elements that form the mat of bristles.

A purpose of the present invention is to provide a suction assembly for a cutting surface of machines for cutting sheet materials, which can be assembled in a fast and simple way and on which operations of replacement of worn-out parts, as well as ordinary cleaning operations, can be easily carried out.

Another purpose of the present invention is to provide a suction assembly which will enable optimal application of the vacuum between the bristles.

A further purpose of the present invention is to provide a suction assembly which will not impede movement of the blade.

Yet another purpose of the present invention is to provide supporting elements making up the suction assembly which are particularly simple and functional, as well as presenting contained costs.

According to the present invention, the above purposes are achieved by providing a suction assembly for a cutting surface, a supporting element for formation of the suction assembly, and a cutting surface for cutting fabrics, as specified in claims 1, 8 and 14.

Further characteristics are specified in the dependent claims.

The characteristics and advantages of a suction assembly according to the present invention will emerge more clearly from the ensuing description, which is provided purely by way of non-limiting example, with reference to the attached schematic drawings, in which:

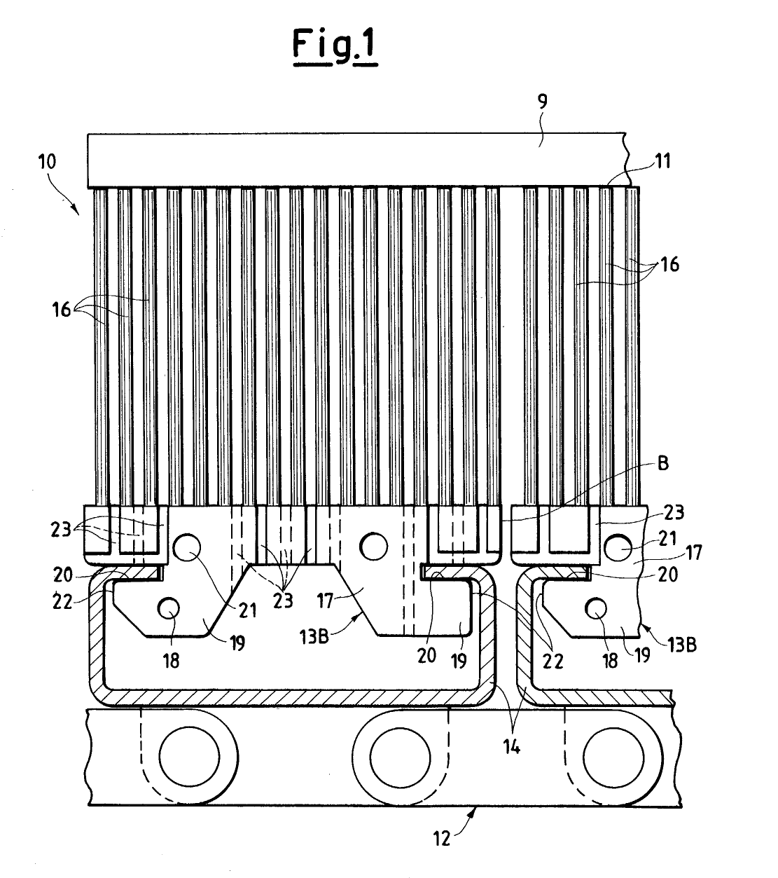

FIG. 1 is a detail of a suction assembly comprising two types of supporting elements for a cutting surface of machines for cutting sheet materials, operated by a chain device;

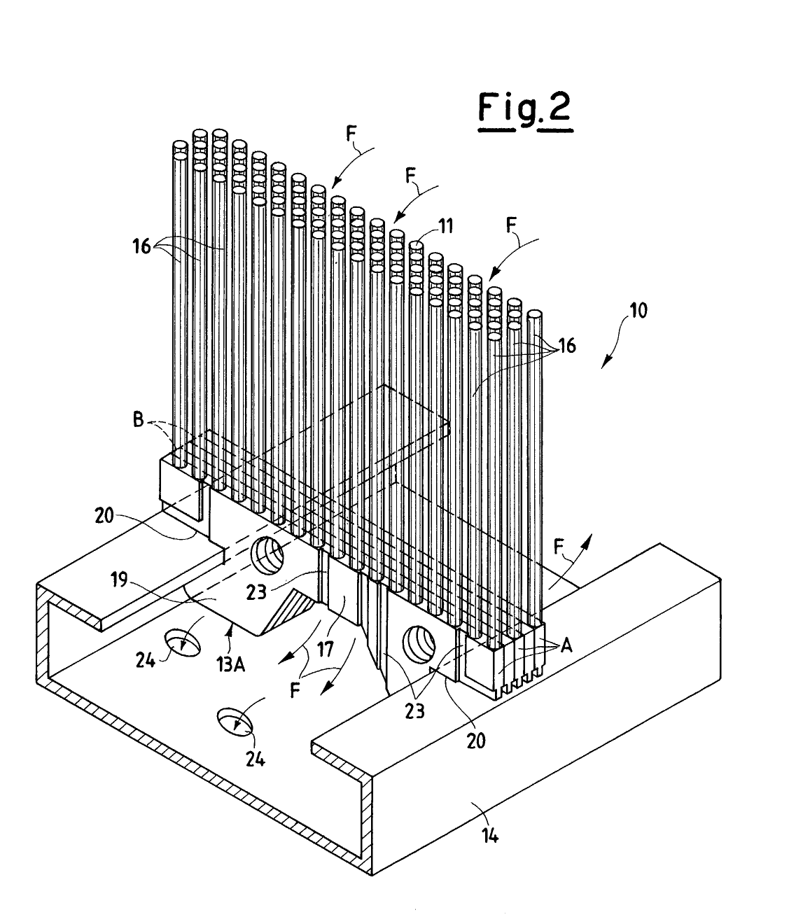

FIG. 2 is a perspective view of a detail of a first embodiment of a suction assembly according to the present invention;

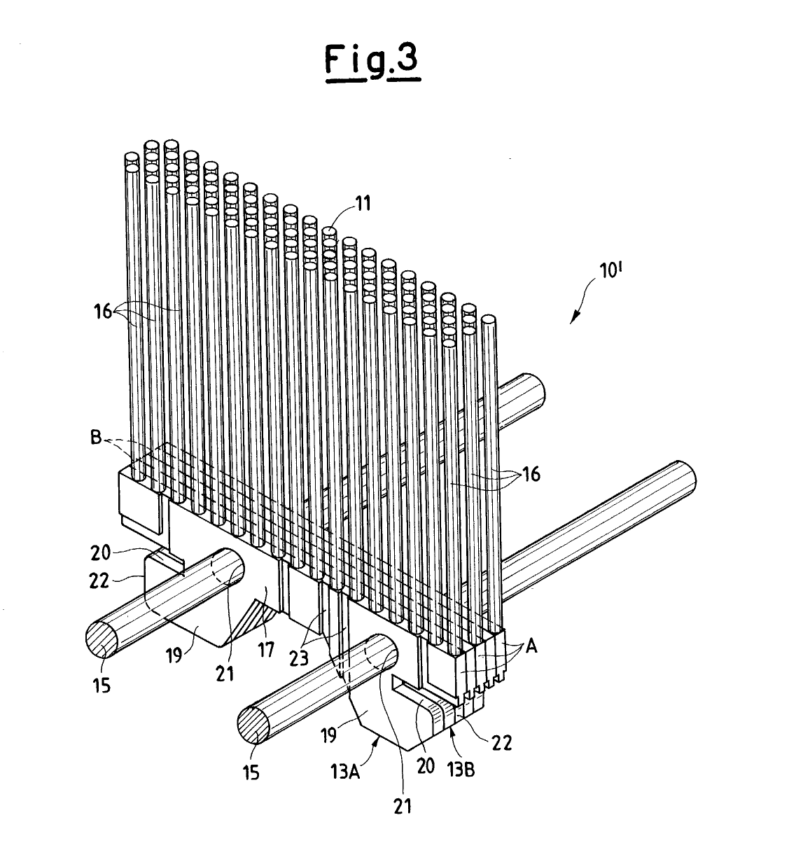

FIG. 3 is a perspective view of a detail of a second embodiment of a suction assembly according to the present invention;

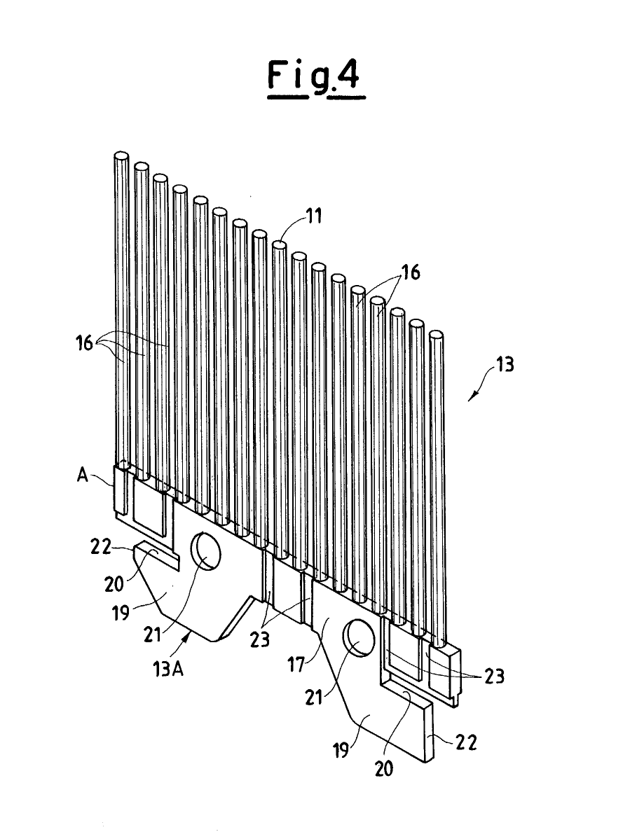

FIG. 4 is a rear-side view of the first supporting element illustrated in FIGS. 2 and 3, turned over through 180°; and

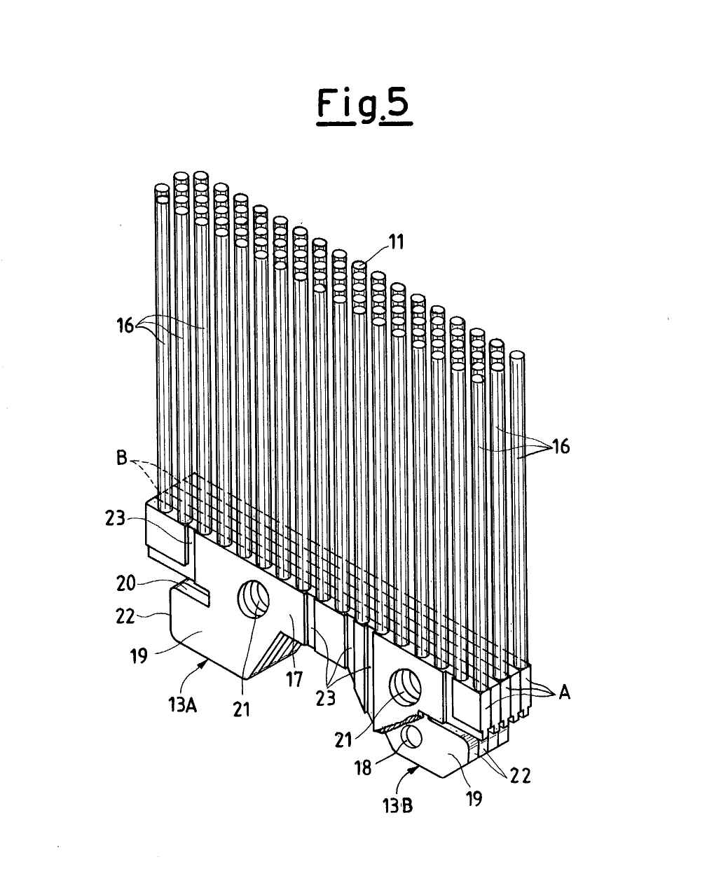

FIG. 5 is a cutaway view of the first supporting element illustrated in FIGS. 2 and 3, in order to highlight the hole for recognition of the underlying element.

With reference to the figures, there is illustrated a suction assembly of supporting elements for sheet materials 9, the said suction assembly being designated as a whole by 10 and 10′ in the two embodiments proposed. In the example given, the cutting operation will regard a fabric.

In FIG. 1, the suction assembly 10 constitutes a portion of a cutting surface 11 of automatic-cutting machines, not illustrated herein because they constitute a consolidated technology that is widely known to the persons skilled in the sector.

The cutting surface 11, which is represented by a mat of bristles, functions as a conveyor belt for feeding of the material that is to be cut, for instance, one operated by a normal chain device 12, as represented schematically purely by way of example in FIG. 1.

The fabric or sheet material 9 is set on the surface 11 in a single sheet or in a pack of sheets.

The suction assembly 10 or 10′ is made up of a plurality of modular supporting elements 13 constrained to a bearing structure, which, according to the embodiments, may be a box section 14 or else parallel rods 15, in accordance with what is illustrated in FIGS. 2 and 3, respectively.

The suction assembly 10 or 10′, which forms a subject of the present invention, is further provided with suction channels that set the bristles 16 in direct communication with the box section 14. In this embodiment, the box section 14, which is provided with suction holes 24 and is connected to a suction system (not illustrated) functions as a suction duct according to the directions indicated by the arrows F in FIG. 2.

The suction pressure applied between the bristles guarantees maximum adherence of the fabric 9 to the cutting plane 11.

The supporting element 13, which forms a subject of the present invention, is illustrated, for example, in FIG. 4, and is made of a modular type of small thickness, according to a comb-like conformation.

The element 13 is equipped with a row of bristles 16 and a base 17 provided with engagement means for insertion into the bearing structure by means of translation.

In fact, two flanges 19 are present, which extend from the base 17 on the side opposite to the bristles 16 and identify two slits 20 for insertion of the box section 14.

Also present are two holes 21 made in the base 17 for constituting means of constraint for insertion of the rods 15.

The two systems of constraint described above may be used either alternatively or in combination.

The flanges 19 have end profiles 22, which are differently shaped to constitute means of orientation for proper insertion of the elements 13 into the bearing structure.

From the figures, it may be clearly seen how the cutting surface 11, on which the fabric 9 is positioned, is made up of a mat of bristles, arranged in chequerboard fashion with voids for increasing the resting surface of the sheet material 9.

In fact, modular elements 13A and 13B are set alongside each other, which are different from one another in the alignment of the bristles, which is made with one of the two opposite sides A or B of the modular element 13, respectively.

The above modular elements 13 are rendered distinguishable from one another by the application of recognition elements, which may be represented by a hole 18, made, in the example illustrated, on the base 17 of the element 13B (FIGS. 1 and 5), or else by a different colouring of the elements 13A and 13B.

The suction channels of the assembly 10 or 10′ are made up of a plurality of grooves 23, represented, for example, parallel and orthogonal to the direction of the bristles 16, preferably distributed on both sides of the base 17 of the modular supporting elements 13.

The modular elements 13A and 13B may differ from one another also by the arrangement of the grooves 23 on the surface of one side or both sides of the base 17, which enables a distribution in space of the suction channels to obtain a uniform adherence of the fabric on the cutting surface 11.

The suction assembly 10 or 10′ illustrated herein envisages, in fact, alternation of the two elements 13A and 13B with grooves 23 arranged differently on their sides.

FIGS. 2 and 3, as well as FIG. 4, respectively illustrate the grooves 23 present on the two sides of the element 13A.

Instead, illustrated in FIG. 1 is the arrangement of the grooves 23 on the two sides of the element 13B, in one case˜i.e., for those in view˜represented by a solid line, and, in the case of the ones on the rear side, represented by a dashed line.

The suction channels thus consist of half-channels or double channels, according to whether the grooves 23 of the two contiguous modular elements 13A and 13B are facing one another or else directly facing the base 17.

The two embodiments illustrated of a suction assembly 10 or 10′, which forms a subject of the present invention, envisage alternate mounting on the bearing structure of modular elements 13B provided with recognition holes 18 and modular elements 13A without the said holes, stacked in such a way that the flanges 19 with end profiles 22 that are the same˜either squared or chamfered˜are superimposed.

There is thus obtained a chequerboard arrangement of the bristles 16 and a spatial distribution of the suction channels made up of the grooves 23 over the entire base 17, according to what has already been described.

The individual comb-like modular elements 13A and 13B are preferably moulded of a single piece made of plastic material.

The modular supporting element thus conceived may undergo numerous modifications and variations, all falling within the scope of the invention, above all as regards the details of the recognition and/or orientation elements, which may be replaced by technically equivalent elements. In practice, the materials used, as well as the dimensions, may be any whatsoever, according to the technical requirements.

The cutting surface 11 of a machine for automatic cutting of fabrics 9 is finally obtained by assemblage, according to known modalities, of a plurality of suction assemblies 10 or 10′ forming the subject of the present invention.

The suction assembly, which forms the subject of the present invention, affords the advantages of being simple to apply to the cutting machine and of enabling fast replacement of the individual worn-out elements, as well as rapid cleaning.

In addition, the individual comb-like elements are inexpensive to produce and are suited for being prearranged with the means of constraint and of recognition.

In the embodiment of the suction assembly applied to a tubular section, this may advantageously function as a suction duct, thus simplifying considerably the structure of the cutting machine.

1. A suction assembly (10, 10′) for a cutting surface (11) of machines for cutting sheet material (9) by means of a blade working with reciprocating motion, comprising a plurality of bristles (16) constrained to a bearing structure (14, 15) to form a resting surface for said sheet material (9), in which said blade freely penetrates, where said assembly (10) is provided with a suction system, the said suction assembly being characterized in that it comprises modular supporting elements (13) of small thickness and comb-shaped, which are provided with a row of bristles (16) and a base (17), provided with engagement means (19, 21), where said elements (13) are inserted, in a removable way, appropriately oriented on said structure (14, 15), thus forming a mat of bristles.

2. The suction assembly (10, 10′) according to claim 1, characterized in that it comprises suction channels consisting of a plurality of grooves (23), made, on at least one side of said base 17 of the modular supporting element (13), where said suction channels consist of half-channels or double channels according to whether said grooves (23) of two contiguous modular elements (13) face one another or face said base (17).

3. The suction assembly (10, 10′) according to claim 1, characterized in that it is made up of at least two types of supporting elements (13A, 13B), in which said row of bristles (16) is differently aligned on one side A or on one side B to form a mat of bristles arranged in chequerboard fashion.

4. The suction assembly (10, 10′) according to claim 3, characterized in that said at least two types of supporting elements (13A, 13B) have different configurations of grooves (23) made in said at least one side of said base (17).

5. The suction assembly (10) according to claim 1, characterized in that said bearing structure consists of box section (14), on which said modular elements (13) are fitted.

6. The suction assembly (10) according to claim 5, characterized in that said box section (14) is a conveying duct connected to said suction system by means of suction channels made up of a plurality of grooves (23) made on at least one side of said base (17) of the supporting elements (13).

7. The suction assembly (10′) according to claim 1, characterized in that said bearing structure consists of rods (15) on which said modular elements (13) are fitted by translation.

8. A supporting element for the formation of a suction assembly (10, 10′) constituting the cutting surface (11) of machines for cutting sheet materials (9), comprising a base (17) equipped with means (19, 20) for engagement with a bearing structure (14, 15) and a plurality of bristles (16), characterized in that it is a modular element (13, 13A, 13B) of small thickness and comb-shaped and is provided with just one row of bristles (16), as well as with means for orientation (22) for proper insertion into the structure (14, 15).

9. The supporting element according to claim 8, characterized in that said means for engagement of the base (17) consist of two flanges (20), which extend from the side opposite to the bristles (16) to identify two sliding slits (20) for insertion of a box section (14).

10. The supporting element according to claim 9, characterized in that said flanges (20) have end profiles (22) differently shaped to constitute said means of orientation for proper insertion of said element (13, 13A, 13B) into the box section (14).

11. The supporting element according to claim 8, characterized in that said means for constraint of the base (17) consist of holes (21) for insertion of parallel rods (15).

12. The supporting element according to claim 8, characterized in that it is provided with a plurality of grooves (23) on at least one side of said base (17).

13. The supporting element according to claim 8, characterized in that it is moulded as a single piece of plastic material.

14. A cutting surface (11) of a machine for cutting sheet materials (9) obtained with a plurality of suction assemblies (10, 10′) according to the present invention.
